(19) United States
(12) Patent Application Publication
(10) Pub. No.: US 2020/0402122 A1
(43) Pub. Date: Dec. 24, 2020

(54) TRANSACTION MANAGEMENT SYSTEM AND TRANSACTION MANAGEMENT METHOD

(71) Applicant: Hitachi, Ltd., Tokyo (JP)

(72) Inventors: Jaesik KIM, Tokyo (JP); Hidenori KIUCHI, Tokyo (JP)

(21) Appl. No.: 16/977,543

(22) PCT Filed: Jan. 8, 2019
(86) PCT No.: PCT/JP2019/000179

§ 371 Date: Sep. 2, 2020

(30) Foreign Application Priority Data
Jun. 5, 2018 (JP) 2018-107581

(51) Int. Cl. G06Q 30/06; G06F 16/28; G06F 16/11; G06Q 30/08; G06Q 10/08

(52) U.S. Cl. CPC G06Q 30/0605; G06F 16/285; G06Q 30/0623; G06Q 30/08; G06Q 10/087; G06F 16/116

(57) ABSTRACT

It is an object of the present invention to provide a transaction management system that enables a buyer company to search for suitable candidate supplier companies from information about existing supplier companies and new supplier companies. For this purpose, a transaction management system 1 is provided with: a data registration function for registering information about e-commerce conducted between a buyer and a supplier, information about a product name that is dealt with in the e-commerce, or information about a category including the product name for each information classification of the e-commerce information, the product name information, or the category information, and a category matching function 127 for performing a comparison between category information registered by the data registration function and category relationship information including a degree of relevance between category information of a buyer and category information of a supplier.

### TECHNICAL FIELD

The present invention relates to a transaction management system and a transaction management method.

### BACKGROUND OF THE INVENTION

In procurement operations between enterprises, a large number of buyer or supplier companies use IT infrastructure systems with unique category code systems, resulting in a structure that makes it difficult to link business processes between enterprises. In particular, even within a single buyer company, supplier company information is stored and managed separately in a plurality of IT infrastructure systems, such that buyer companies fall into a situation in which they cannot accurately and easily acquire information on products and services provided by supplier companies. Against this backdrop, there is a growing need for services that enable buyers to select appropriate suppliers from global supplier company management information that does not depend on individual buyers (including organizations such as internal departments that conduct procurement).

For example, Patent Document 1 discloses a system for providing a supplier company searching device which calculates a similarity between a search condition of an individual buyer and a combination of category code systems which can be provided by an existing supplier company set in advance by the buyer company when searching for a supplier company, and correctly and quickly extracts a supplier company from which a substitute part can be procured.

In addition, since buyer companies need to efficiently set category code systems of the buyer company with respect to the category code system of various supplier companies, Patent Document 2 discloses a setting support method for determining the category code system for each data item and displaying the setting priority.

### CITATION LIST

### Patent Literature

[Patent Document 1] Japanese Unexamined Patent Application Publication No. 2014-048862

[Patent Document 2] Japanese Unexamined Patent Application Publication No. 2007-025868

### SUMMARY OF INVENTION

### Technical Problem

In the supplier company searching device described in Patent Document 1, an alternative candidate supplier company can be searched based on the category code system of an existing supplier company registered by the buyer company. However, in the case that the category code system is altogether different in the first place, or if a buyer company enters an incorrect category code system with respect to an existing supplier company, or if input of a category code system is not entered, a suitable alternative candidate supplier company cannot be searched. In addition, in the case that an alternative candidate supplier company is not found with respect to the search conditions of the individual buyer, offline work problems, such as an individual buyer conducting an alternative candidate supplier company survey to ask other individual buyers or the other departments, cannot be solved.

Further, in the setting support method described in Patent Document 2, since the setting priority order of the category code system calculated on the basis of related items determined in advance for each data item is determined, when the products and services of a large number of supplier companies are modified, an individual buyer cannot correctly and efficiently reclassify the category code systems of all the supplier companies.

In order to solve the above-mentioned problems, an object of the present invention is to provide a transaction management system and a transaction management method in which a buyer company can search for an appropriate candidate supplier company from information about existing supplier companies with which the buyer company has had transactions and new supplier companies.

### Means for Solving the Problem

In order to solve the above-mentioned problems, a transaction management system and a method thereof are provided for managing transactions between a buyer and a supplier by using information on e-commerce between the buyer and the supplier, the transaction management system comprising a data registration function configured to register information about e-commerce conducted between a buyer and a supplier, information about a product name that is dealt with in the e-commerce, or information about a category including a product name for each information classification of e-commerce information, product name information, or category information; and a category matching function configured to perform a comparison between category information registered by the data registration function and category relationship information including a degree of relevance between category information of a buyer and category information of a supplier, wherein: when category information related to an unregistered product name code is detected in product name information, the data registration function registers the detected category information, and when a category relationship is detected in category information registered by the data registration function, the category matching function registers information indicating the degree of relevance in category relationship information.

### Advantageous Effects of Invention

According to the present invention, a buyer company can efficiently select an appropriate candidate supplier company from accurate and consistent supplier company management information, and supplier companies have a greater probability of conducting transactions with buyer companies with which they do not have transaction records.

### BRIEF DESCRIPTION OF DRAWINGS

FIG. 1 is an overall configuration diagram of a transaction management system according to an embodiment of the present invention.

FIG. 2 is a table configuration diagram of file reception information according to an embodiment of the present invention.

FIG. 3 illustrates an example of the contents of an estimate information file specified in file reception information according to an embodiment of the present invention.

FIG. 4 illustrates an example of the contents of an order information file specified in file reception information according to an embodiment of the present invention.

FIG. 5 is a table configuration diagram of transaction data information according to an embodiment of the present invention.

FIG. 6 is a table configuration diagram of buyer product name information according to an embodiment of the present invention.

FIG. 7 is a table configuration diagram of supplier product name information according to an embodiment of the present invention.

FIG. 8 is a table configuration diagram of category registration request information according to an embodiment of the present invention.

FIG. 9 is a table configuration diagram of buyer category information according to an embodiment of the present invention.

FIG. 10 is a table configuration diagram of supplier category information according to an embodiment of the present invention.

FIG. 11 is a table configuration diagram of category relationship information according to an embodiment of the present invention.

FIG. 12 is a table configuration diagram of shared category name dictionary information according to an embodiment of the present invention.

FIG. 13 is a flowchart illustrating a process of receiving data files required for registration by a file reception function of a file reception according to an embodiment of the present invention.

FIG. 14 is a flowchart illustrating a process of registering a transaction data file received by the file data registration function of the file reception server according to an embodiment of the present invention.

FIG. 15 is a flowchart illustrating a process of registering a product name data file of a buyer company received by the file data registration function of the file reception server according to an embodiment of the present invention.

FIG. 16 is a flowchart illustrating a process of registering a product name data file of a supplier company received by the file data registration function of the file reception server, according to an embodiment of the present invention.

FIG. 17 is a flowchart illustrating a process of updating data by the list registration function of the application server and a process of transmitting a data file to the file reception server by the file transmission function, according to an embodiment of the present invention.

FIG. 18 is a flowchart illustrating a process in which the shared category registration function of the application server registers the category data of a buyer company acquired from the category registration request information, according to an embodiment of the present invention.

FIG. 19 is a flowchart illustrating a process in which the shared category registration function of the application server registers the category data of a supplier company acquired from the category registration request information, according to an embodiment of the present invention.

FIG. 20 is a flowchart illustrating a process in which the shared category registration function of the application server registers the category name of a buyer company in the shared category name dictionary information, according to an embodiment of the present invention.

FIG. 21 is a flowchart illustrating a process in which the category matching function of the application server registers the information of a supplier company with respect to a category name of a buyer company in the category relationship information of the buyer company, according to an embodiment of the present invention.

FIG. 22 is a flowchart illustrating a process in which the shared category registration function of the application server registers a category name of a supplier company in the shared category name dictionary information, according to an embodiment of the present invention.

FIG. 23 is a flowchart illustrating a process in which the category matching function of the application server updates the category relation information of a buyer company with respect to the category name of the supplier company, according to an embodiment of the present invention.

FIG. 24 is an example of an operation input screen and an output display screen displayed on a user terminal of a buyer company and a user terminal of the supplier company, according to an embodiment of the present invention.

### DESCRIPTION OF EMBODIMENT(S)

Hereinafter, embodiments of the present invention will be described in detail with reference to the accompanying drawings.

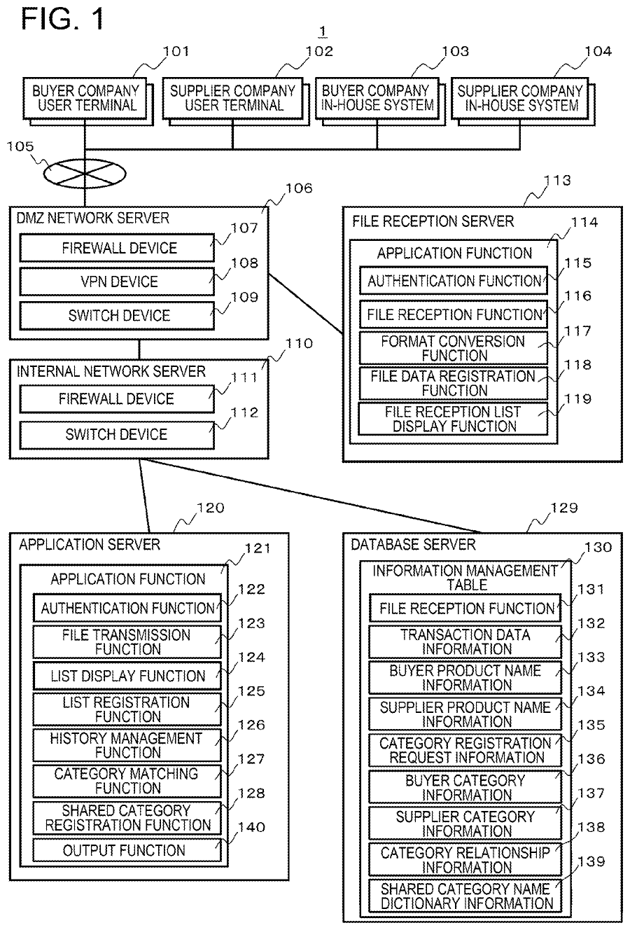

FIG. 1 is a diagram illustrating an example of the overall configuration of a transaction management system 1 that implements a matching technique for a category code system used in an inter-enterprise transaction. The transaction management system 1 includes a plurality of buyer company user terminals 101, supplier company user terminals 102, buyer company in-house systems 103, supplier company in-house systems 104, and a DMZ network server 106 connected to a network 105 such as the Internet. Access to the plurality of buyer company user terminals 101, supplier company user terminals 102, buyer company in-house systems 103, and supplier company in-house systems 104 is controlled by a firewall device 107 and a VPN device 108 of the DMZ network server 106. The file reception server 113 is connected to the DMZ network server 106, and the application server 120 and the database server 129 are connected to the internal network server 110. Data is transmitted and received between each computer via the network 105, the DMZ network server 106 and the internal network server 110.

The firewall device 107 of the DMZ network server 106 determines, for each connection destination, whether or not the connection destination is set in advance in the firewall device 107, and permits connection to the internal network server 110 through the switch device 109 for the buyer company user terminal 101 and the supplier company user terminal 102. The VPN device 108 of the DMZ network server 106 determines whether the buyer company in-house system 103 and the supplier company in-house system 104 are set in the VPN device 108, and permits connection to the file reception server 113 via the switch device 109.

The firewall device 111 of the internal network server 110 permits only connections from the DMZ network server 106 that are previously set in the firewall device 111, and each connection destination uses the application function 121 of the application server 120 through the switch device 112.

The application function 114 of the file reception server 113 is configured by an authentication function 115 for authenticating a connection destination, a file reception function 116 for receiving a data file transmitted from a connection destination and storing it in the file reception information 131 of the database server 129, a format conversion function 117 for converting the received data file into the format of the information management table 130 of the database server 129, a file data registration function 118 for performing registration in each table of the information management table 130 of the database server 129 according to the type of information of the format converted data, and a file reception list display function 119.

The application function 121 of the application server 120 includes an authentication function 122 for authenticating a connection destination, a file transmission function 123 for transmitting a data file from the application server 120 to the file reception server 113, a list display function 124 for displaying a list of the contents and retrieved results of the information management table 130 stored in the database server 129, a list registration function 125 for updating data for each information classification from the displayed list, a history management function 126 for managing the updated history, a category matching function 127 for analyzing the registered data, a shared category registration function 128 for registering the analyzed results, and an output function 140 for electronically and visually outputting the information.

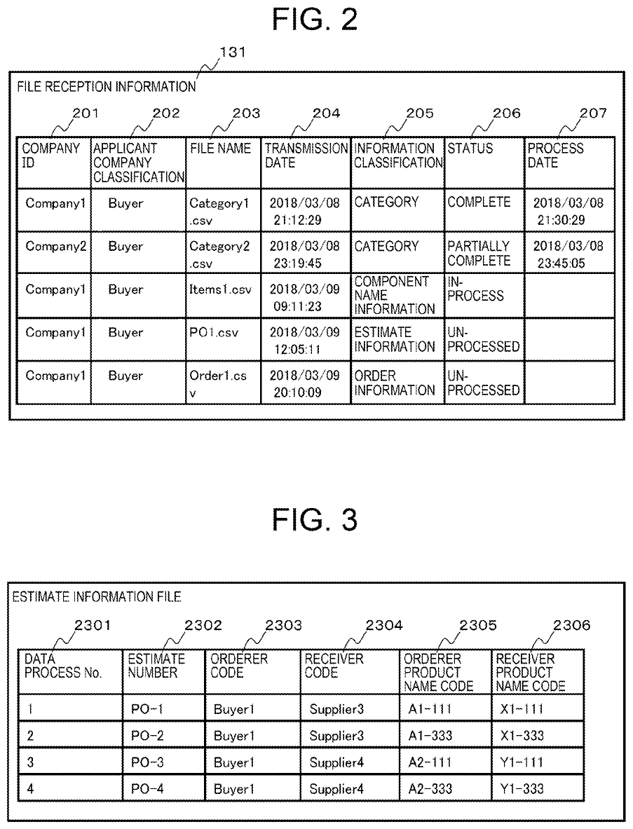

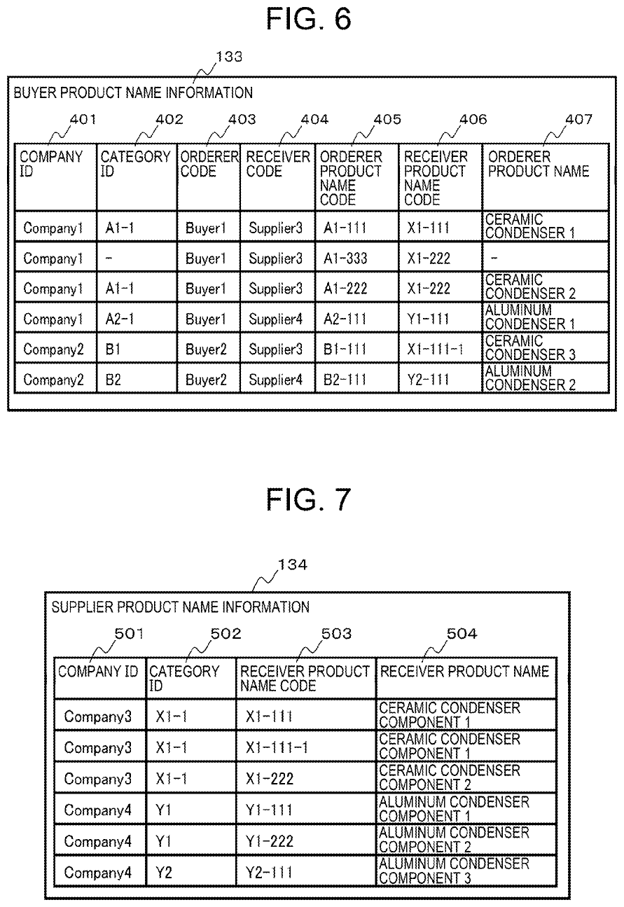

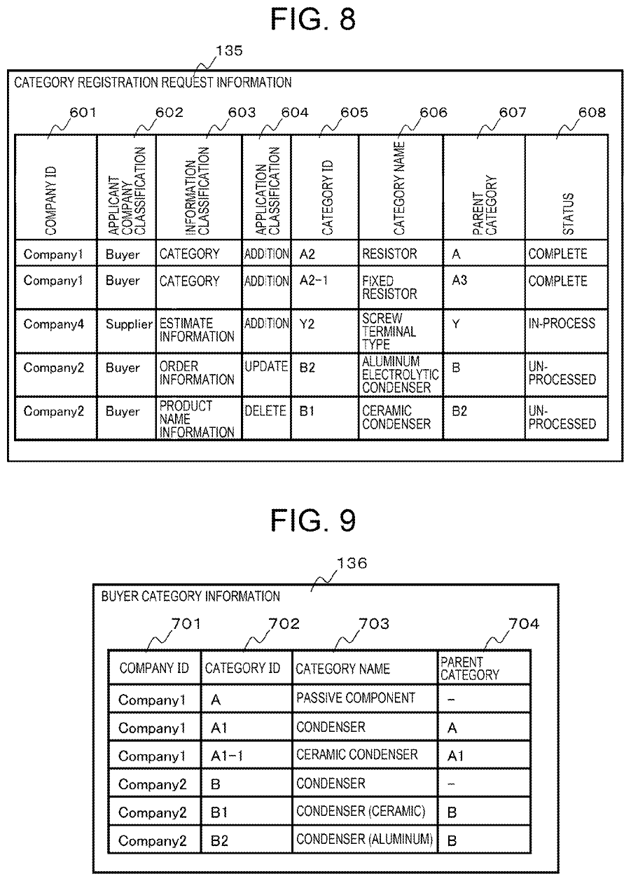

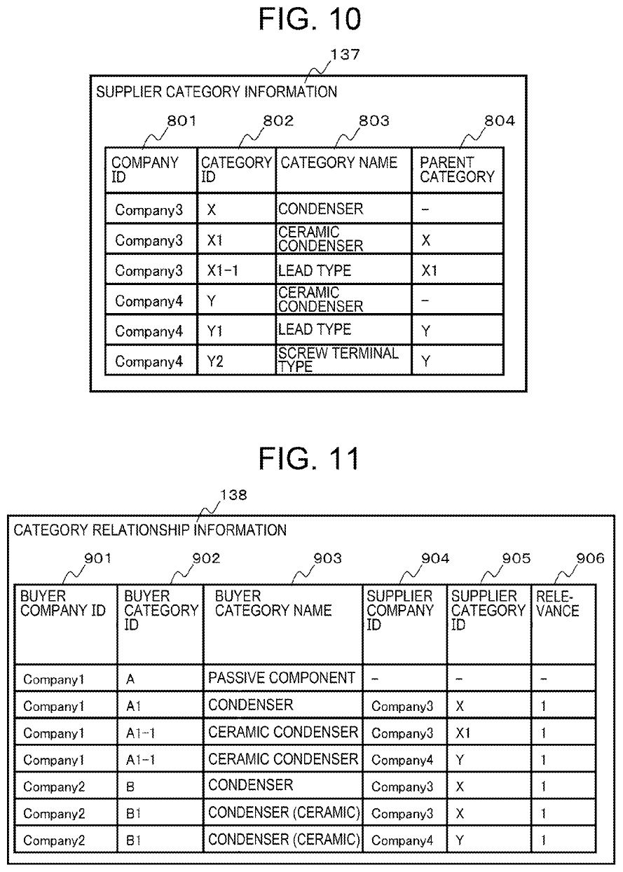

The database server 129 includes an information management table 130 in which data registered from a buyer company or a supplier company and analyzed data are stored. The information management table 130 will be described with reference to FIG. 2, FIG. 5, FIG. 6, FIG. 7, FIG. 8, FIG. 9, FIG. 10, and FIG. 11.

Although not illustrated in the figures, the buyer company user terminal 101, the supplier company user terminal 102, the buyer company in-house system 103, and the supplier company in-house system 104 that serve as connection destinations can be implemented by a general computers, which include a control unit such as a CPU, a storage unit, an input unit, a display unit, a network interface unit, and the like. In addition, regarding the authentication of the connection destination, the buyer company and the supplier company are registered in advance as company information (information of a company ID, a company name, an orderer code, a receiver code, and the like) and user information (information of a company ID, a user ID, a user PW, a user name, and the like), and the authentication function 115 of the file reception server 113 and the authentication function 122 of the application server 120 are used at the time of the authentication processing. In addition, the DMZ network server 106, the internal network server 110, the file reception server 113, the application server 120, and the database server 129 include at least a control unit such as a CPU, a storage unit, a network interface unit, and the like, and operate a dedicated or general-purpose operating system.

FIG. 2 is a diagram illustrating a data configuration example of the file reception information 131 in the information management table 130 in the database server 129. The file reception information 131 stores a company ID 201, an applicant company classification 202, a file name 203, a transmission date 204, an information classification 205, a status 206, and a process date 207. The company ID 201 is an identification code of the company that registers the data file. The applicant company classification 202 distinguishes the companies that register data files, such that buyer companies are represented as Buyer, and supplier companies are represented as Supplier. The file name 203 is the data file name to be registered. The transmission date 204 is the date and time when the data file was received, and is represented in the “YYYY/MM/DD HH:MM:SS” format. The information classification 205 is the information classification (estimate information, order information, category, product name information) of the data file received by the file reception function 116. The status 206 is the result of processing (in-process, partially completed, completed) by the format conversion function 117 and the file data registration function 118 that the file reception function 116 has not processed. The process date 207 is the date and time when the format conversion function 117 and the file data registration function 118 performed processing, and is expressed in the “YYYY/MM/DD HH:MM:SS” format.

For example, in the first line of the file reception information 131 illustrated in this figure, “Company1” is stored in the company ID 201, “Buyer” is stored in the applicant company classification 202, “Category1.csv” is stored in the file name 203, “2018/03/08 21:12:29” is stored in the transmission date 204, “category” is stored in the information classification 205, “complete” is stored in the status 206, and “2018/03/08 21:30:29” is stored in the process date 207. This line indicates that the company “Company1”, which is a “Buyer”, registered a data file “Category1.csv” that includes category information on this transmission date, and processing of this data file was completed on this process date.

In addition, in the fourth line of the file reception information 131 illustrated in this figure, “Company1” is stored in the company ID 201, “Buyer” is stored in the applicant company classification 202, “PO1.csv” is stored in the file name 203, “2018/03/09 12:05:11” is stored in the transmission date 204, “estimate information” is stored in the information classification 205, “un-processed” is stored in the status 206, and “NULL” is stored in the processing date 207. This line indicates that the company “Company1”, which is a “Buyer”, registered a data file “PO1.csv” that includes “Estimate Information” at this transmission date, and this data file is waiting to be processed.

The contents of the data file name specified by the file name 203 usually differ according to the information classification 205. In the case that the information classification 205 is estimate information, the content of the data file name includes a data process No 2301, an estimate number 2302, an orderer code 2303, a receiver code 2304, an orderer product name code 2305, and a receiver product name code 2306, as illustrated in FIG. 3. Data files that include estimate information include the product name codes of the orderer and the receiver in association with each other. For example, in the first line of the estimate information file illustrated in this figure (for example, “PO1.csv” specified in the fourth line of the file reception information 131), “1” is listed in the data process No 2301, “PO-1” is listed in the estimate number 2302, “Buyer” is listed in the orderer code 2303, “Supplier3” is listed in the receiver code 2304, “A1-111” is listed in the orderer product name code 2305, and “X1-111” is listed in the receiver product name code 2306.

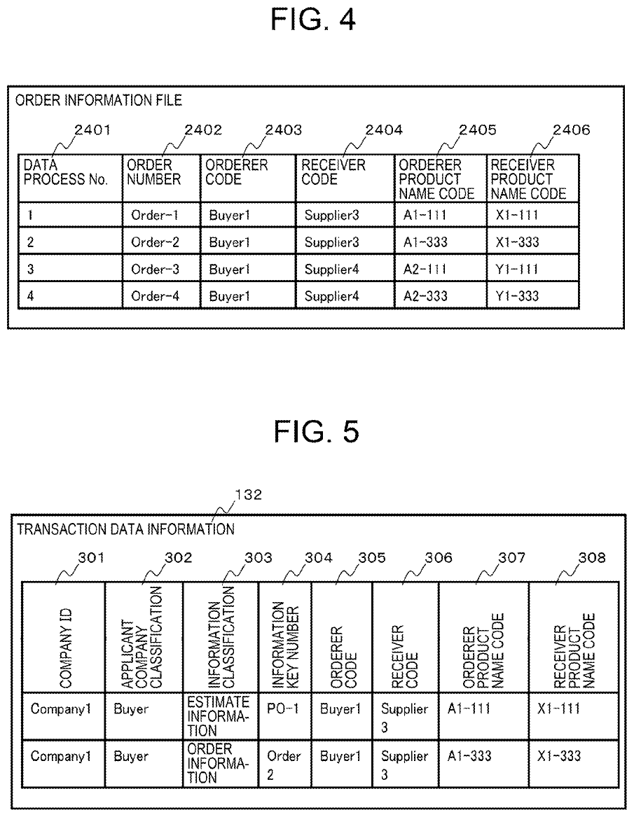

In the case that the information classification 205 is order information, the content of the data file name includes a data process No 2401, an order number 2402, an orderer code 2403, a receiver code 2404, an orderer product name code 2405, and a receiver product name code 2406, as illustrated in FIG. 4. Data files that include order information include the product name codes of the orderer and the receiver in association with each other. For example, in the first line of the order information file illustrated in this figure (for example, “Order1.csv” specified in the fifth line of the file reception information 131), “1” is listed in the data process No 2401, “Order-1” is listed in the order number 2402, “Buyer1” is listed in the orderer code 2403, “Supplier3” is written in the receiver code 2404, “A1-111” is listed in the orderer product name code 2405, and “X1-111” is listed in the receiver product name code 2406.

Although not illustrated in the figures, in the case that the information classification 205 is product name information, it includes at least the product name code, which is the product name information, and the orderer code or the receiver code that uses the product name code. In addition, in the case that the information classification 205 is a category, it includes at least the category ID that serves as the category information and the product name information included therein, and the orderer code or the receiver code that uses the category ID. In this way, including the contents of the data file specified by the file name 203, the file reception information 131 includes estimate information or order information, which is information about e-commerce conducted between the orderer (the buyer company) and the receiver (the supplier company), a product name code which is product name information to be dealt with in the e-commerce, or category information including the product name, in addition to the information classifications (estimate information, order information, category, product name information) corresponding to the e-commerce information, the product name information, or the category information.

FIG. 5 is a diagram illustrating a data configuration example of the transaction data information 132 of the information management table 130 held in the database server 129. The transaction data information 132 stores a company ID 301, an applicant company classification 302, an information classification 303, an information key number 304, an orderer code 305, a receiver code 306, an orderer product name code 307, and a receiver product name code 308. The company ID 301 is the company ID 201 of the file reception data 131 of the registered data file. The applicant company classification 302 is the applicant company classification 202 of the file reception information 131 of the registered data file. The information classification 303 is the information classification 205 of the file reception information 131 of the registered data file. The information key number 304 is a unique key assigned to each information classification and is represented by unique characters of the buyer company that registers the data file. The orderer code 305 is represented by unique characters of the buyer company that registered the data file as an identification code managed by the buyer company for the buyer company. The receiver code 306 is represented by unique characters of the buyer company that registered the data file as an identification code managed by the buyer company for the supplier company. The orderer product name code 307 is represented by unique characters of the buyer company that registered the data file as an identification code managed by the buyer company for the product name of the buyer company. The receiver product name code 308 is represented by unique characters provided by the supplier company to the buyer company as an identification code managed by the buyer company for the product name of the supplier company.

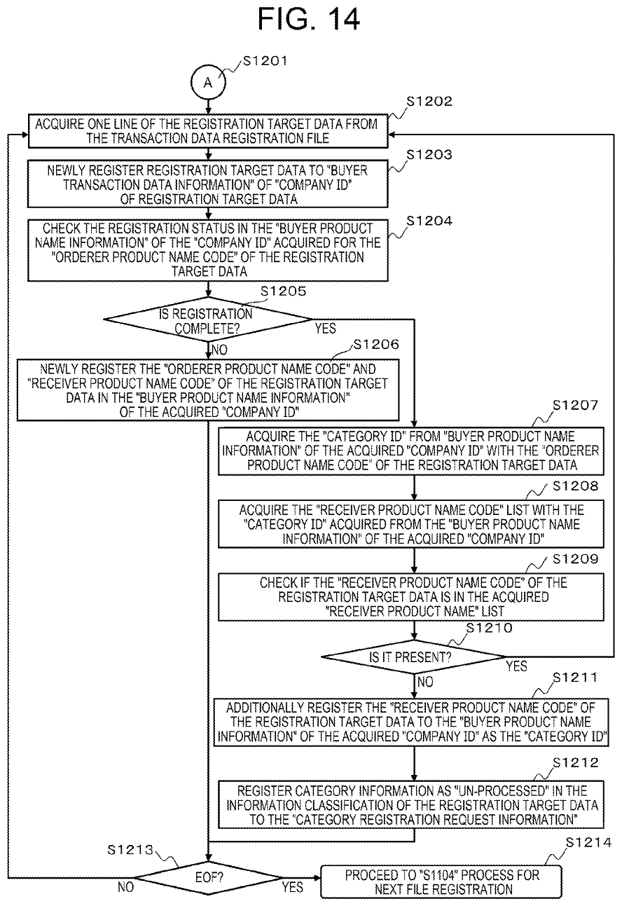

For example, in the first line of the transaction data 132 illustrated in this figure, “Company1” is stored in the company ID 301, “Buyer” is stored in the applicant company classification 302, “estimate information” is stored in the information classification 303, “PO-1” is stored in the information key number 304, “Buyer1” is stored in the orderer code 305, “Supplier3” is stored in the receiver code 306, “A1-111” is stored in the orderer product name code 307, and “X1-111” is stored in the receiver product name code 308. This line indicates that the company “Company1”, which is a “Buyer,” exchanged “estimate information” referred to by information key number 304 “PO-1” with respect to a component with an orderer name code “A1-111” of the orderer code “Buyer” and a component with the receiver name code “X1-111” of the receiver code “Supplier3”. Each line of the transaction data information 132 is registered based on the data file of the transaction data by the file data registration function 118. The details thereof will be described in FIG. 14.

FIG. 6 is a diagram illustrating a data configuration example of the buyer product name information 133 of the information management table 130 held in the database server 129. The buyer product name information 133 stores a company ID 401, a category ID 402, an orderer code 403, a receiver code 404, an orderer product name code 405, a receiver product name code 406, and an orderer product name 407. The company ID 401 is the company ID 201 of the file reception information 131 of the company information data updated from the list registration function 125 or the data file registered by the file data registration function 118. The category ID 402 is represented by the unique characters of the buyer company that registered the data file as a category identifier managed by the buyer company for the product name of the buyer company. The orderer code 403 is represented by unique characters of the buyer company that registered the data file as an identification code managed by the buyer company for the buyer company. The receiver code 404 is represented by unique characters of the buyer company that registered the data file as an identification code managed by the buyer company for the product name of the supplier company. The orderer product name code 405 is represented by unique characters of the buyer company that registered the data file as an identification code managed by the buyer company for the product name of the buyer company. The receiver product name code 406 is represented by unique characters provided by the supplier company to the buyer company as an identification code managed by the buyer company for the product name of the supplier company. The orderer product name 407 is represented by unique characters of the buyer company that registered the data file as a product name managed by the buyer company for the buyer company.

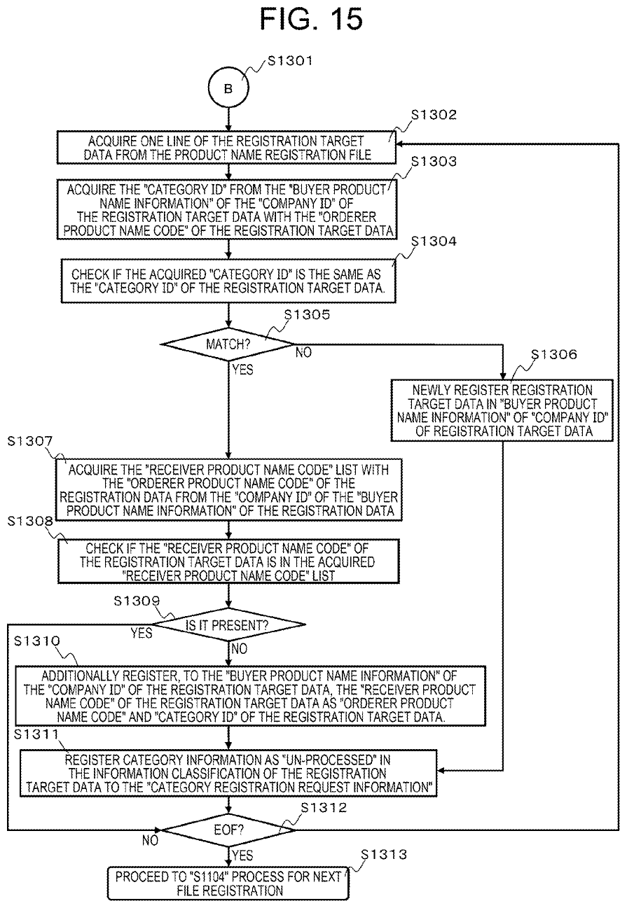

In this way, in the buyer product name information 133, the orderer product name code 405 and the orderer product name 407 of the buyer company and the receiver product name code 406 of the supplier company for this buyer company are associated with each other for a particular product name. In addition, the buyer product name information 133 stores a portion of the code system of the component name of the buyer company. For example, in the first line of the buyer product name information 133 illustrated in this drawing, “Company1” is stored in the company ID 401, “A1-1” is stored in the category ID 402, “Buyer1” is stored in the orderer code 403, “Supplier3” is stored in the receiver code 404, “A1-111” is stored in the orderer product name code 405, “X1-111” is stored in the receiver product name code 406, and “ceramic condenser 1” is stored in the orderer product name 407. This line indicates that the buyer company “Company1” uses the orderer product name code “A1-111” to correspond to the receiver product name code “X1-111”, and that the orderer product name code “A1-111” uses “ceramic condenser 1” as its name, and is included in the category ID “A1-1” that serves as an upper group. Each line of the buyer product name information 133 is registered by the file data registration function 118 based on the transaction data information 132 or the like. The details thereof will be described in FIG. 15.

FIG. 7 is a diagram illustrating a data configuration example of the supplier product name information 134 of the information management table 130 held in the database server 129. The supplier product name data 134 stores a company ID 501, a category ID 502, a receiver product name code 503, and a receiver product name 504. The company ID 501 is the company ID 201 of the file reception information 131 of the company information updated from the list registration function 125 or the data file registered by the file data registration function 118. The category ID 502 is represented by unique characters of the supplier company that registered the data file as a category identifier managed by the supplier company for the product name of the supplier company. The receiver product name code 503 is represented by unique characters of the supplier company that registered the data file as an identification code managed by the supplier company for the product name of the supplier company. The receiver product name 504 is represented by unique characters of the supplier company that registered the data file as a product name managed by the supplier company for the supplier company.

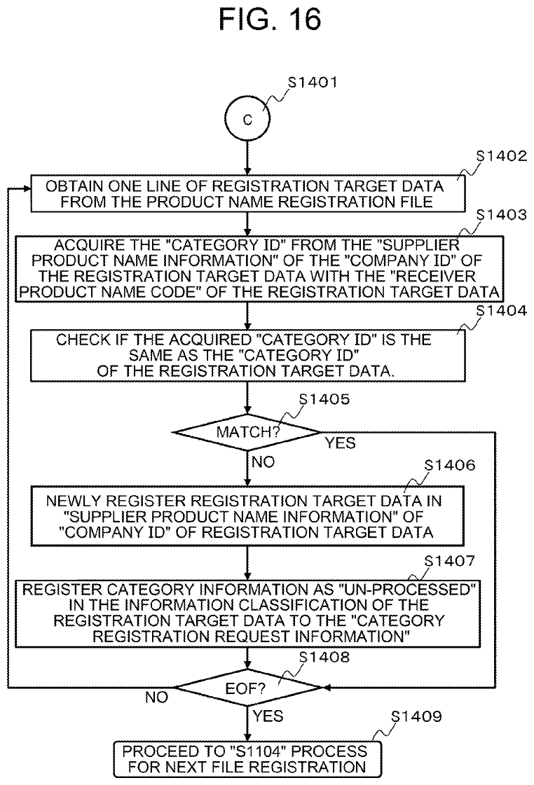

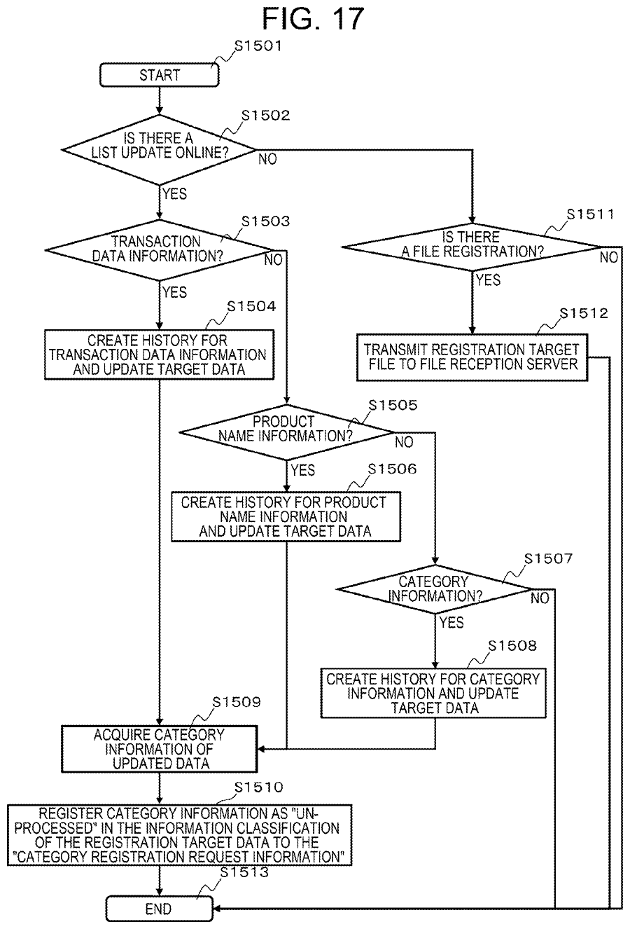

In this way, since the supplier company side is typically unaware of product name information such as the product name code of the buyer company side, the supplier product name information 134 does not include any association with the product name code of the buyer company, and includes the receiver product name code 503 of the supplier company, the upper category ID 502 that includes the receiver product name code 503, and the receiver product name 504 that serves as the product name corresponding to the receiver product name code 503. In the supplier product name information 134, a portion of the code system of the component name in the supplier company is stored. For example, in the first line of the supplier product name information 134 illustrated in this drawing, “Company3” is stored in the company ID 501, “X1-1” is stored in the category ID 502, “X1-111” is stored in the receiver product name code 503, and “ceramic condenser component 1” is stored in the receiver product name code 504. This line indicates that the supplier company “Company3” uses the receiver product name code “X1-111”, uses “ceramic condenser component 1” as its name, and that “ceramic condenser component 1” is included in the category ID “X1-1” that serves as the upper group. Each line of the supplier product name information 134 is registered by the file data registration function 118 based on the data file of the product name information. The details thereof will be described in FIG. 16.

FIG. 8 is a diagram illustrating a data configuration example of the category registration request information 135 of the information management table 130 held in the database server 129. The category registration request information 135 stores a company ID 601, an applicant company classification 602, an information classification 603, an application classification 604, a category ID 605, a category name 606, a parent category 607, and a status 608. Company ID 601 is the company ID 201 of the file reception information 131 of the company information data updated from the list registration function 125 or the data file registered by the file data registration function 118. The applicant company classification 602 distinguishes the company ID 201 of the file reception information 131 of the company information data updated from the list registration function 125 or the data file registered by the file data registration function 118 such that buyer companies are represented as Buyer, and supplier companies are represented as Supplier. The information classification 603 is the information classification 205 of the file reception information 131 of the registered data file. The application classification 604 is the application classification (new, updated, deleted) of each data line of the data file data updated from the list registration function 125 or registered by the file data registration function 118. The category ID 605 is the category identifier of the data file data updated or registered on the list screen. The category name 606 is the category name of the data file data updated from the list registration function 118 or registered by the file data registration function 125. The parent category 607 is the parent category of the data file data updated from the list registration function 118 or registered by the file data registration function 125. The status 608 is the result of processing (in-process, partially completed, completed) by the category matching function 127 that the file data registration function 118 has not yet processed.

The category registration request information 135 stores information for registering, to the buyer category information 136 and the supplier category information 137 to be described later, an upper parent category including the category ID, the category name, and the category ID. For example, in the first line of the category registration request information 135 illustrated in this figure, “Company1” is stored in the company ID 601, “Buyer” is stored in the applicant company classification 602, “category” information is stored in the information classification 603, “addition” is stored in the application category 604, “A2” is stored in the category ID 605, “resistor” is stored in the category name 606, “A” is stored in the parent category 607, and “complete” is stored in the status 608. This line indicates that a buyer company “Company1” tried to register a category of A with a category ID of A2 (category name: resistor) as category information to the buyer category information 136, and that the processing is complete. Each line of the category registration request information 135 is registered by the file data registration function 118 based on the transaction data information 132, the buyer product name information 133, and the like. The details thereof will be described in FIG. 14 to FIG. 16.

FIG. 9 is a diagram illustrating a data configuration example of the buyer category information 136 of the information management table 130 held in the database server 129. The buyer category information 136 stores a company ID 701, a category ID 702, a category name 703, and a parent category 704. The company ID 701 is the company ID 201 of the file reception information 131 of the company information data updated from the list registration function 125 or the data file registered by the file data registration function 118. The category ID 702 is a category ID 605 acquired from the category registration request information 135. The category name 703 is a category name 606 acquired from the category registration request information 135. The parent category 704 is the parent category 607 obtained from the category registration request information 135.

For example, in the second line of the buyer category information 136 illustrated in this figure, “Company1” is stored in the company ID 701, “A1” is stored in the category ID 702, “condenser” is stored in the category name 703, and “A” is stored in the parent category 704. This line indicates that, in the buyer company “Company1” the category ID “A1” is named “condenser” and its parent category is “A”. In addition,

in the first line of the buyer category information 136 illustrated in this figure, “Company1” is stored in the company ID 701, “A” is stored in the category ID 702, “passive component” is stored in the category name 703, and “NULL” is stored in the parent category 704. This line indicates that, in “Company1”, the category ID “A” is named “passive component”, and that there is no parent category; that is, “A” is the highest category. In addition, in the third line of the buyer category information 136 illustrated in this drawing, “Company1” is stored in the company ID 701, “A1-1” is stored in the category ID 702, “ceramic condenser” is stored in the category name 703, and “A1” is stored in the parent category information 704. This line means that, in “Company1”, the category ID “A1-1” is named “ceramic condenser”, and its parent category is “A1”. Accordingly, the buyer category information 136 indicates that category ID “A1-1” is included in the category ID “A1” of the category ID, that category ID “A1” is included in category ID “A”, and stores a portion of the code system of the component names in the buyer company.

FIG. 10 is a diagram illustrating a data configuration example of the supplier category information 137 of the information management table 130 held in the database server 129. The supplier category information 137 stores company ID 801, a category ID 802, a category name 803, and a parent category 804. The company ID 801 is the company ID 201 of the file reception information 131 of the company information data updated from the list registration function 125 or the data file registered by the file data registration function 118. The category ID 802 is the category ID 605 acquired from the category registration request information 135. The category name 803 is the category name 606 acquired from the category registration request information 135. The parent category 804 is the parent category 607 obtained from the category registration request information 135.

For example, in the second line of the supplier category information 137 illustrated in this figure, “Company3” is stored in the company ID 801, “X1” is stored in the category ID 802, “ceramic condenser” is stored in the category name 803, and “X” is stored in the parent category information 804. This line indicates that, in the supplier company “Company3”, the category ID “X1” is named “ceramic condenser”, and that the parental category thereof is “X”. In addition, in the first line of the supplier category information 137 illustrated in this figure, “Company3” is stored in the company ID 801, “X” is stored in the category ID 802, “condenser” is stored in the category name 803, and “NULL” is stored in the parent category 804. This line indicates that, in “Company3”, the category ID “X” is named “condenser”, and “X” is the highest category. In addition, in the third line of the supplier category information 137 illustrated in this figure, “Company3” is stored in the company ID 801, “X1-1” is stored in the category ID 802, “Lead Type” is stored in the category name 803, and “X1” is stored in the parent category 804. This line indicates that, in “Company3”, the category ID “X1-1” is named “lead type,” and its parent category is “X1”. Accordingly, this indicates that category ID “X1-1” is included in the category ID “X1”, the category ID “X1” is included in the category ID “X”, and the supplier category information 137 stores a portion of the code system of the component names in the supplier company.

FIG. 11 is a diagram illustrating a data configuration example of the category relationship information 138 of the information management table 130 held in the database server 129. The category relation data 138 stores a buyer company ID 901, a buyer category ID 902, a buyer category name 903, a supplier company ID 904, a supplier category ID 905, and a degree of relevance 906. The buyer company ID 901 is the company ID 201 of the file reception information 131 of the company information data updated from the list registration function 125 or the data file registered by the file data registration function 118. The buyer category ID 902 is a category ID 702 registered in the buyer category data 136. The buyer category name 903 is a category name 703 registered in the buyer category information 136. The supplier company ID 904 is the company ID 801 of the supplier category data 137. The supplier category ID 905 is the category ID 802 of the supplier category data 137. The degree of relevance 906 is a result of processing by the category matching function 127 (1: category match, 2: estimate present, 3: order present), and is a value that indicates the degree of relevance between the category information of the buyer company and the category information of the supplier company.

In the case that the degree of relevance 906 is NULL, the degree of relevance indicates that there is no name code of another department that is considered to coincide with the name code used in a particular department, for example. In the case that the degree of relevance 906 is 1, the degree of relevance indicates that the product name code used in a particular department and the product name code used in another department are apparently different, but the actual product (component) itself is the same. In the case that the degree of relevance 906 is 2, the degree of relevance indicates that the product name code used in a particular department and the product name code used in another department are apparently different, but the actual product (component) itself is the same, and that this is a product name code that has a record of having an estimate actually taken, and can be said to be a degree of relevance with higher reliability. In the case that the degree of relevance 906 is 3, similarly, the degree of relevance indicates a product name code with a record of having an order actually placed using that product name code, and can be said to be a degree of relevance with an even higher reliability. By referring to the degree of relevance, buyer companies can select a supplier company based on the degree of reliability of the supplier company.

For example, in the second line of the category relationship information 138 illustrated in this figure, “Company1” is stored in the buyer company ID 901, “A1” is stored in the buyer category ID 902, “condenser” is stored in the buyer category name 903, “Company3” is stored in the supplier company ID 904, “X” is stored in the supplier category ID 905, and “1” is stored in the degree of relevance 906. This line indicates that in the buyer company “Company1”, the buyer category ID “A1” is named “condenser” and for this buyer category ID, the suppler company “Company3” assigns “X” as the supplier category ID. In addition, the fact that the degree of relevance 906 is “1” indicates that there is a record that “A1” of the buyer category ID matches “X” of the supplier category ID based on the category matching function 127.

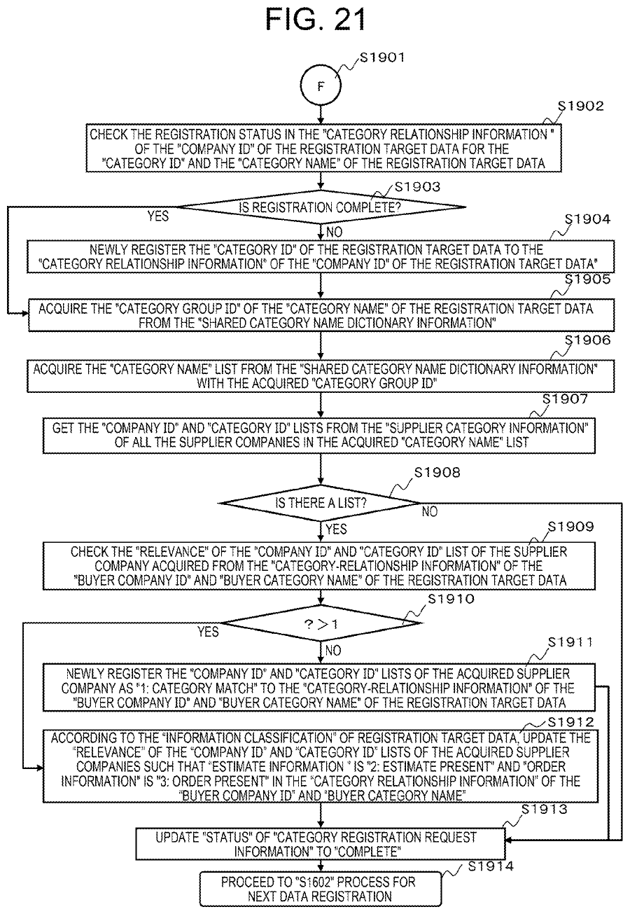

In addition, in the first line of the category relationship information 138 illustrated in this figure, “Company1” is stored in the buyer company ID 901, “A” is stored in the buyer category ID 902, “passive component” is stored in the buyer category name 903, “NULL” is stored in the supplier company ID 904, “NULL” is stored in the supplier category ID 905, and “NULL” is stored in the degree of relevance 906. This line indicates that, in the buyer company “Company1”, the name “passive component” is used for the buyer category ID “A”, but there is no supplier having a supplier category ID 905 for that buyer category ID, or at least one has not been confirmed. Also, the fact that the degree of relevance 906 is “NULL” indicates that there is no matching category ID in both based on the category matching function 127. Each line of the category relationship information 138 is registered based on a data record or the like acquired by the category matching function 127. The details thereof will be described in FIG. 21.

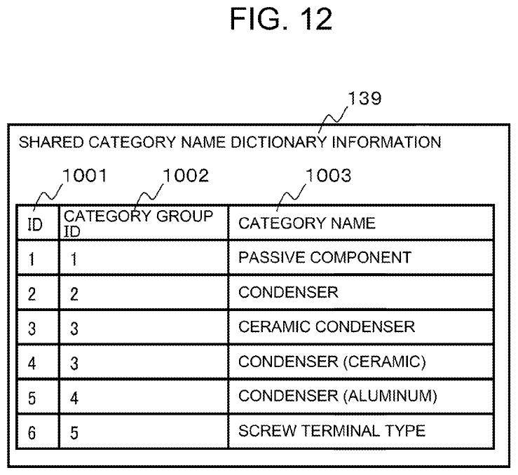

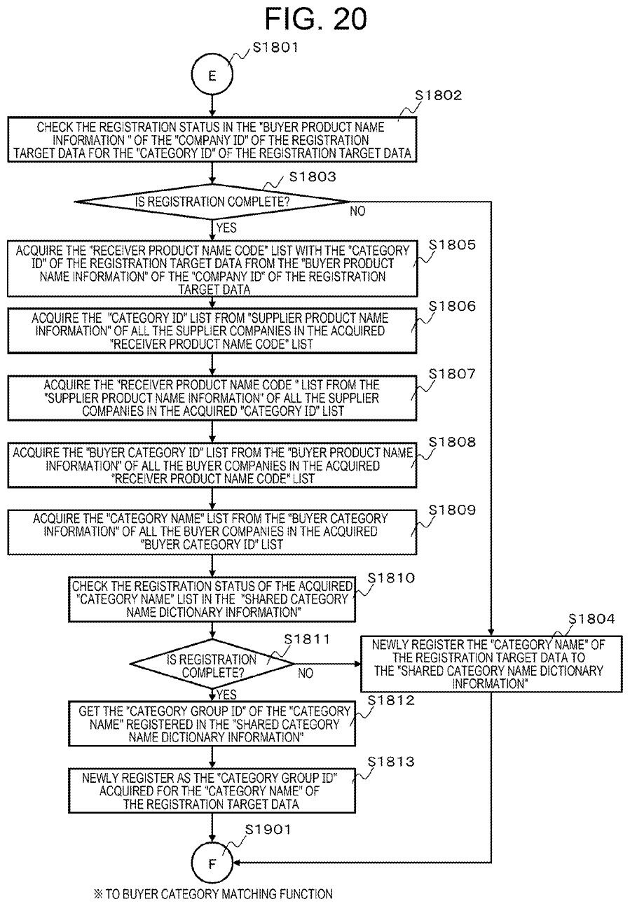

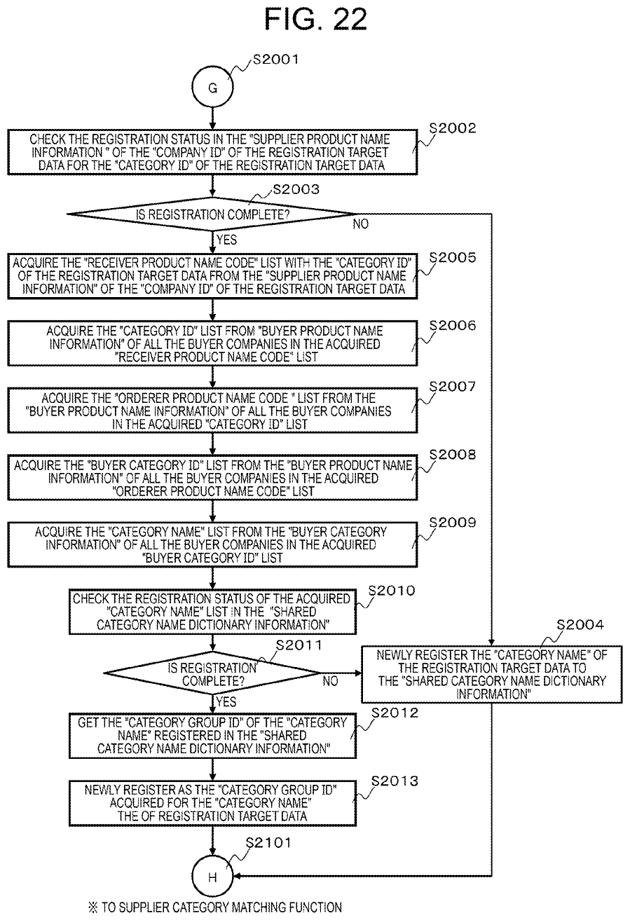

FIG. 12 is a diagram illustrating a data configuration example of the shared category name dictionary information 139 held in the information management table 130 in the database server 129. The shared category name dictionary information 139 stores an ID 1001, a category group ID 1002, and a category name 1003. The ID 1001 is a unique key assigned to each record and is represented by a random combination of single-byte alphanumeric characters. The category group ID 1002 is a unique key assigned to the same categories, and is represented by a random combination of single-byte alphanumeric characters. The category name 1003 is the category name 606 of the category registration request information 135. For example, in the first line of the shared category name dictionary information 139 illustrated in this figure, “1” is stored in ID 1001, “1” is stored in the category group ID 1002, and “passive component” is stored in the category name 1003. The shared category name dictionary information 139 is registered based on the category registration request information 135 by the shared category registration function 128. The details thereof will be described in FIG. 20 and FIG. 22.

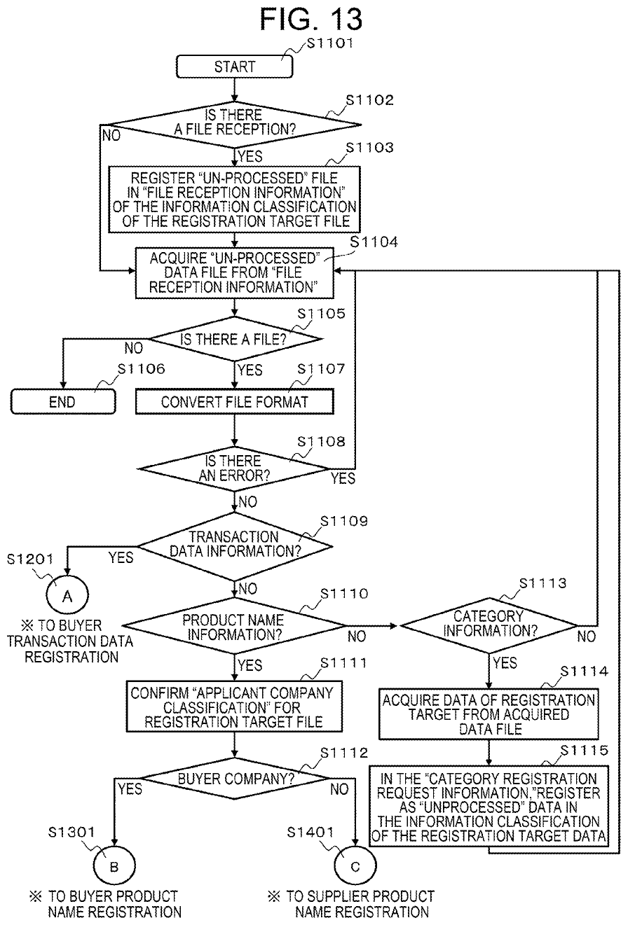

FIG. 13 is a flowchart illustrating a process in which the file reception function 116 of the file reception server 113 receives the data files necessary for registration and distinguishes the received data files for each information classification. The file reception function 116 checks (S1102) whether or not a data file transmitted by the file transmission function 123 that transmits the buyer company in-house system 103, the supplier company in-house system 104, and the data file from the application server 120 to the file reception server 113 has been received. In the case that the data file has been received, the file reception function 116 registers (S1103) the received data file as an un-processed file (status 206: un-processed) data record in the information classification 205 according to the information classification of the registration target data file in the file reception information 131. In the case that the data file has not been received, the processing of S1103 is skipped. The format conversion function 117 acquires an un-processed data file from the file reception information 131 (S1104).

The format conversion function 117 checks (S1105) whether there is an un-processed data file in the file reception information 131. If there are no unprocessed data files, the processing terminates (S1106). In the case that there is an un-processed data file, the format conversion function 117 performs a format conversion on the acquired un-processed data file according to the information management table 130 for the data file (S1107). In the case that an error occurs during the format conversion, the next un-processed data file is processed (S1104), and in the case that there is no error, the file data registration function 118 processes the data file that has been format-converted for each information classification 205 of the file reception information 131 (S1108).

Whether the information classification 205 of the acquired data file is transaction data (estimate information, order information) is checked (S1109), and in the case that it is transaction data, the file data registration function 118 performs a buyer transaction data registration process (S1201). In the case that it is not transaction data, the file data registration function 118 checks whether the information classification 205 of the acquired data file is product name information (S1110), and in the case that it is product name information, it checks the applicant company classification 202 of the file reception information 131 (S1111). The file data registration function 118 performs the buyer product name registration process (S1301) in the case that the applicant company classification 202 is a buyer company, and performs the supplier product name registration process (S1401) in the case that the applicant company classification 202 is a supplier company (S1112).

In the case that the information classification 205 was not the product name information at S1110, the file data registration function 118 checks whether it is category information (S1113). In the case that it is not category information, the next un-processed data files are processed (S1104). In the case that the information classification 205 is category information, the file data registration function 118 acquires all the data lines from the data file (S1114) and registers the acquired data lines as un-processed data files in the category registration request information 135 (S1115). Then, the next unprocessed data file is processed (S1104).

FIG. 14 is a flowchart illustrating a process in which the file data registration function 118 of the file reception server 113 registers a data file in which the information classification 205 of the data file acquired from the file reception information 131 is transaction data (estimate information, order information) to the transaction data information 132, the buyer product name information 133, and the category registration request information 135. The file data registration function 118 acquires a data line from the data file of the transaction data (S1202), and newly registers the acquired data line in the transaction data information 132 as the company ID 201 of the file reception information 131 (S1203). The file data registration function 118 checks whether or not the orderer product name code 307 of the registered transaction data information 132 is registered in the orderer product name code 405 of the buyer product name information 133 for the company ID 201 of the file reception information 131 (S1204).

If not registered in S1205, the file data registration function 118 newly registers the company ID 301, the orderer code 305, the orderer product name code 307, and the receiver code 306 of the transaction data information 132 in the orderer code 403, the orderer product name code 405, and the receiver code 404 of the buyer product name information 133, respectively (S1206), and processes the following data lines until the end of the data file (S1213). If registered in S1205, the file data registration function 118 acquires the category ID 402 from the buyer product name information 133 using the company ID 301 of the transaction data information 132 and the orderer product name code 307 (S1207), and extracts a list of the receiver product name code 406 from the buyer product name information 133 based on the acquired category ID 402 (S1208). The file data registration function 118 checks whether the receiver product name code 308 of the transaction data information 132 is in the list of the extracted receiver product name code 406 (S1209), and if the receiver product name code 308 is in the list of the receiver product name code 406, processes the next data line (S1210).

If not listed in the receiver product name code 406, the file data registration function 118 additionally registers the company ID 301, the orderer code 305, the orderer product name code 307, and the receiver code 306 of the transaction data information 132 in the orderer code 403, the orderer product name code 405, and the receiver code 404 of the buyer product name information 133 as the obtained category ID 402, respectively (S1211). In addition, the file data registration function 118 registers the company ID 301, the applicant company category 302, and the information classification 303 of the transaction data information 132 and the category ID 402 of the buyer product name information 133 in the category registration request information 135 (S1212), and processes the following data line (S1213). In the case that all the data lines have been processed, the processing (S1104) of the next data file is performed (S1214).

Typically, the transaction data (the estimate information and the order information) does not include category information, but since there is information associating the product codes of both products, candidate supplier companies can be searched with high reliability by utilizing this association and analyzing this association in combination with other information such as the buyer product name information 133 and the supplier product name information 134 in the information management table 130.

FIG. 15 is a flowchart illustrating a process in which the file data registration function 118 of the file reception server 113 registers, in the buyer product name information 133 and the category registration request information 135, a data file in which the applicant company classification 202 of the file reception information 131 is buyer and the information classification 205 is product name information. The file data registration function 118 acquires (S1302) a data line from the data file of the product name information, extracts the category ID 402 from the company ID and the buyer product name information 133 of the orderer product name code (S1303) of the acquired data line (S1303), and checks whether the extracted category ID 402 matches the category ID of the acquired data line (S1304).

In the case that there is not match at S1305, the file data registration function 118 newly registers the acquired data line in the buyer product name information 133 (S1306) and registers, in the category registration request information 135, the category information as un-processed (status 608: unprocessed) in the information classification 603 with the information classification of the registration target data file (S1311). In the case that there is a match in S1305, the file data registration function 118 extracts a list of the receiver product name code 406 from the buyer product name information 133 based on the company ID and the orderer product name code of the acquired data line (S1307), and checks whether or not the receiver product name code of the acquired data line exists in the extracted list of the receiver product name code 406 (S1308).

If not listed in the receiver product name code 406, the file data registration function 118 additionally registers the receiver product name code of the acquired data line as the extracted company ID 401, the category ID 402, and the orderer product name code 405 in the buyer product name information 133 (S1310), and registers it in the category registration request information 135 (S1311). If listed in the list of the receiver product name code 406, the file data registration function 118 registers the following data line (S1312). In the case that all the data lines have been processed, processing (S1104) of the next data file is performed (S1313).

FIG. 16 is a flowchart illustrating a process in which the file data registration function 118 of the file reception server 113 registers, in the supplier product name information 134 and the category registration request information 135, a data file in which the applicant company classification 202 of the file reception information 131 is supplier and the information classification 205 is product name information. The file data registration function 118 acquires a data line from the data file of the product name information (S1402). The file data registration function 118 extracts the category ID 502 from the supplier product name information 134 based on the company ID and the receiver product name code of the acquired data line (S1403), and checks whether the extracted category ID 502 matches the category ID of the acquired data line (S1404).

In the case that there is not match at S1405, the file data registration function 118 newly registers the acquired data line in the supplier product name information 134 (S1406) and registers, in the category registration request information 135, the category information as unprocessed (status 608: unprocessed) in the information classification 603 with the information classification of registration target file (S1407). In the case that there is a match, the file data registration function 118 performs the registration process of the following data line (S1408). In the case that all the data lines have been processed, processing (S1104) of the next data file is performed (S1409).

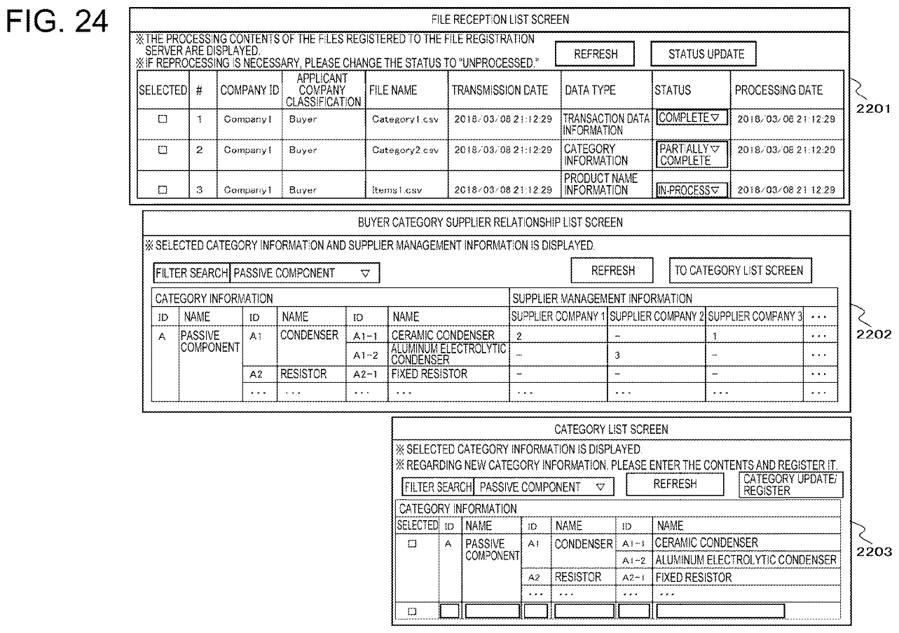

FIG. 17 is a flowchart illustrating a process in which the list display function 124 of the application server 120 lists the data in the information management table 130, the list registration function 125 data updates the data, and the file transmission function 123 transmits the data file to the file reception server 113. The list display function 124 provides a list display screen requested from the buyer company user terminal 101 and the supplier company user terminal 102 (for example, list display screens such as the file reception list screen (2201) that displays information from the file reception information 131 as a list display screen, the buyer category supplier relationship list screen (2202) that displays information from the category relationship information 138, and the category list screen (2203) for displaying information from the buyer category information 136 and the supplier category information 137, as illustrated in FIG. 24), and provides a data update function from the list screen.

The list registration function 125 is a function for registering data to be updated from the list display screen for each information classification, and registers data to be updated from the list display screen in the transaction data information 132, the buyer product name information 133, or the supplier product name information 134, and the category registration request information 135 for each information classification. In this way, a user can perform data update via this screen, thereby providing an easy-to-use transaction management system 1. By means of such a data update function, the list registration function 125 allows individual buyers and individual suppliers to upload data files from the buyer company user terminal 101 and the supplier company user terminal 102 to update their transaction data, product name codes, and category codes. In addition, the list registration function 125 enables users to reference the registered transaction data information 132, the buyer product name information 133, the supplier product name information 134, the buyer category information 136, the supplier category information 137, and the like, and to update the information of each data item displayed in the list. With regard to the updated data items, the category relationship information 138 and the shared category name dictionary information 139 of the buyer company can be updated by once again analyzing the category relationship.

As illustrated in FIG. 24, the file reception list screen, the buyer category supplier relationship list screen (2202), and the category list screen (2203) are examples of operation input screens and output display screens that are displayed on the buyer company user terminal 101 and the supplier company user terminal 102. These screens are output by the output function 140 in the application function 121 of the application server 120 and displayed on the buyer company user terminal 101 and the supplier company user terminal 102. The file reception list screen (2201) searches from the file reception information 131 and displays a list of search results. The processing can be performed again by selecting the received file list and changing the status of the selected file.

The buyer category supplier relationship list screen (2202) is retrieved from the buyer category information 136 and the category relationship information 138, and the search results are displayed in a list. In the buyer category supplier relationship list screen 2202, supplier company information related to the buyer category information 136 registered by the buyer company is displayed. The category list screen (2203) searches from the buyer category information 136 and the supplier category information 137 and lists the search results. In the category list screen (2203), it is possible to perform the processing again by selecting from the registered category list and changing the contents of the selected category.

It should be noted that, in the present embodiment, the output function 140 displayed information on the screen so that the user can recognize it visually, but the present invention is not limited to this, and the degree of relevance and the like may be electronically output by being transmitted to another system or the like. In this way, it is possible to indicate the degree of relevance or the like to other systems or users.

A check is performed of whether the data has been updated from the list screen by the list registration function 125 (S1502), and in the case that the data has been updated, the list registration function 125 checks whether the information of the updated data is transaction data (estimate information, order information) (S1503). In the case that it is transaction data, the list registration function 125 creates a history of the transaction data information 132 displayed in the list and updates the transaction data information 132 from the information of the updated data (S1504). In the case that the information of the updated data is not transaction data, the list registration function 125 checks whether or not it is product name information (S1505).

In the case it is product name information, the list registration function 125 creates a history of the product name information displayed in the list, and updates the buyer product name information 133 or the supplier product name information 134 from the updated information (S1506). In the case that the information of the updated data is not the product name information, the list registration function 125 checks whether it is the category information (S1507). In the case that it is category information, the list registration function 125 creates a history of the category information displayed in the list and updates the buyer category information 136 or the supplier category information 137 from the information of the updated data (S1508). In the case that it is not category information, processing is terminated.

The list registration function 125 reacquires the category information from the updated transaction data information 132, the article name information, or the category information (S1509), and registers the acquired category information as un-processed data in the category registration request information 135 (S1510). In addition, in the case that there was no data update by the list registration function 125 from the list screen in S1502, a check is performed of whether or not the data files required for registration have been received from the list screen from the file transmission function 123 (S1511), and in the case that the data file has been received, the file transmission function 123 transmits the data file to the file reception server 113 (S1512). In the case that the data file has not been received, the process ends.

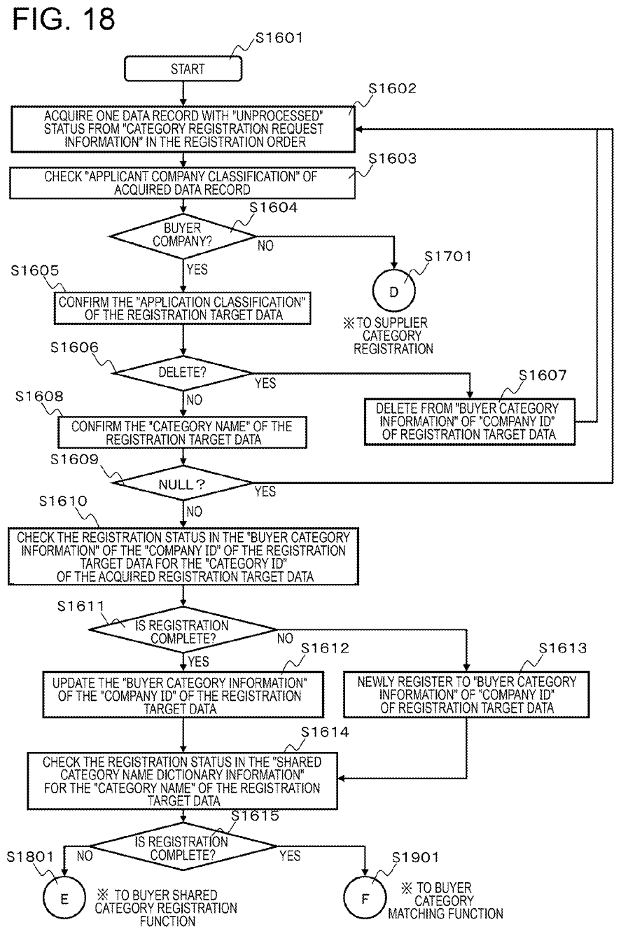

FIG. 18 is a flowchart illustrating a process in which the shared category registration function 128 of the application server 120 registers the category data of the buyer company acquired from the category registration request information 135. The shared category registration function 128 has a function for registering unregistered category information in the shared category name dictionary information 139. The shared category registration function 128 acquires a data record with a status 608 of unprocessed from the category registration request information 135 (S1602), checks the applicant company classification 602 of the acquired data record (S1603), and performs the supplier category registration process (S1701) when the applicant company classification 602 is supplier (S1604).

In the case that the applicant company classification 602 of the acquired data record is Buyer, the shared category registration function 128 checks the application classification 604 (S1606) and deletes the company ID 601 and category ID 605 of the acquired data record from the buyer category information 136 when the applicant company classification 602 is “delete” (S1607). In the case that the application classification 604 of the acquired data record is “addition” or “update”, the shared category registration function 128 checks whether the category name 606 of the acquired data record is NULL (S1609), and in the case that the category name 606 is NULL, processing of the next data record (S1602) is performed (S1609). In the case that the category name 606 is not NULL, the shared category registration function 128 checks whether the company ID 601 of the acquired data record and the category ID 605 are registered in the buyer category information 136 (S1610).

If registered, the shared category registration function 128 updates the company ID 601 of the acquired data record and the buyer category information 136 of the category ID 605 with the acquired data record (S1612). If it is not registered, the shared category registration function 128 newly registers the acquired data record in the buyer category information 136 (S1613). The shared category registration function 128 checks (S1614) whether or not the category name 606 of the updated or registered acquired data record is registered in the shared category name dictionary information 139, performs the buyer shared category dictionary registration function process (S1801) when it is not registered, and performs the buyer category matching function process (S1901) when it is registered (S1615).

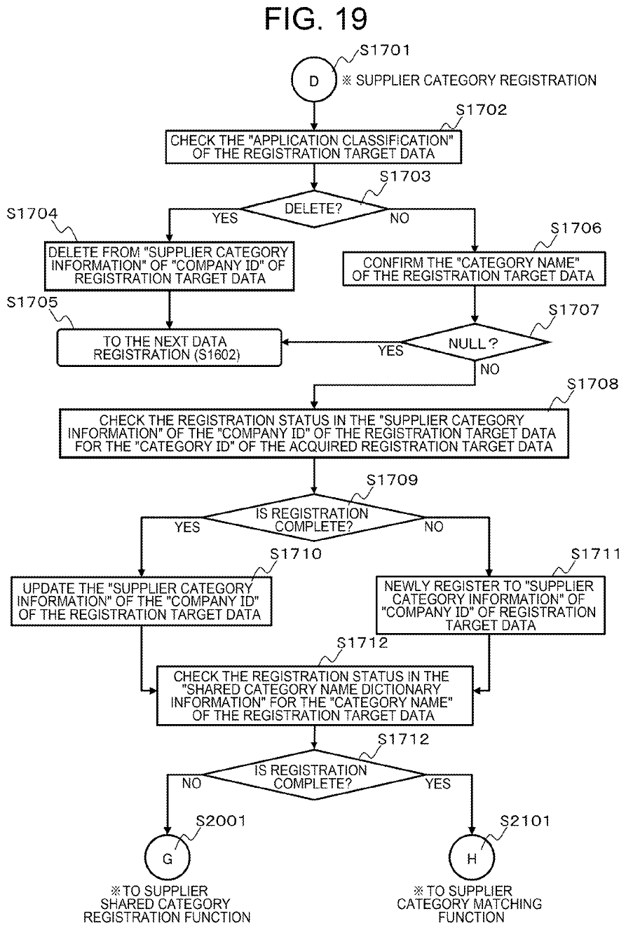

FIG. 19 is a flowchart illustrating a process in which the shared category registration function 128 of the application server 120 registers category data of the supplier company acquired from the category registration request information 135. The shared category registration function 128 checks (S1702) the application classification 604 of the data record acquired from the category registration request information 135, deletes (S1704) the company ID 601 and category ID 605 of the acquired data record from the supplier category information 137 when the application classification 604 is “delete”, and registration (S1602) of the next data record is performed (S1705). When the application category 604 of the acquired data record is “addition” or “update”, the shared category registration function 128 checks whether or not the category name 606 of the acquired data record is NULL (S1706). In the case that the category name 606 of the acquired data record is NULL, registration (S1602) of the next data record is performed (S1707).

In the case that the category name 606 of the retrieved data record is not NULL, the shared category registration function 128 checks whether the company ID 601 and the category ID 605 of the acquired data record are registered in the supplier category information 137 (S1708). In the case that they are registered, the shared category registration function 128 updates the supplier category information 137 of the company ID 601 and the supplier category information 137 of the acquired data record with the category name 606 of the acquired data record (S1710). In the case that they are not registered, the shared category registration function 128 newly registers the company ID 601, the category ID 605, and the category name 606 of the acquired data record in the supplier category information 137 (S1711). The shared category registration function 128 checks whether or not the category name 606 of the updated or registered acquired data record is registered in the shared category name dictionary information 139 (S1712), performs the supplier shared category dictionary registration function (S2001) in the case that it is not registered, and performs the buyer category matching function (S2101) in the case that it is registered.

FIG. 20 is a flowchart illustrating a process in which the shared category registration function 128 of the application server 120 registers the category name of the buyer company in the shared category name dictionary information 139. The shared category registration function 128 checks whether or not the category name 606 of the data record acquired from the category registration request information 135 is registered in the buyer product name information 133 for a data record that is not registered in the shared category name dictionary information 139 (S1802). If it is not registered in S1803, the shared category registration function 128 newly registers the category name 606 of the acquired data record in the shared category name dictionary information 139 (S1804), and then the buyer category matching function process is performed (S1901).

In the case that it is registered in S1803, the shared category registration function 128 extracts the list of the receiver product name code 406 from the buyer product name information 133 based on the category name 606 of the acquired data record (S1805). The shared category registration function 128 extracts the list of the category ID 502 from the supplier product name information 134 based on the extracted list of the receiver product name code 406 (S1806). Based on the extracted list of the category ID 502, the list of the receiver product name code 503 is extracted from the supplier product name information 134 (S1807). The shared category registration function 128 extracts the list of category ID 402 from the buyer product name information 133 based on the extracted list of the recipient product name code 503 (S1808). The shared category registration function 128 extracts a list of category names 703 from the buyer category information 136 based on the extracted list of the category ID 402 (S1809). The shared category registration function 128 checks whether the extracted list of the category names 703 is registered in the shared category name dictionary information 139 (S1810), and in the case that it is not registered (S1811), newly registers the category name 606 of the acquired data record in the shared category name dictionary information 139 (S1804).

In the case that it is registered (S1811), the shared category registration function 128 extracts the category group ID 1002 (S1812) and registers the category name 606 of the acquired data record as the extracted category group ID 1002 in the shared category name dictionary information 139 (S1813). The buyer category matching function (S1901) is performed for the registered category name 1003. In this way, in the case that the category name for the registered product name code is not registered in the shared category name dictionary information 139, the shared category registration function 128 extracts all the category IDs registered as the product name code from the buyer product name information 133 or the supplier product name information 134, and acquires the category name from the buyer category information 136 or the supplier category information 137 with the extracted category ID.

In this way, it becomes possible to facilitate acquisition of category names, and even if there is a category code system of a supplier company that cannot be specified, it is possible to update the shared category name dictionary information 139 by re-analyzing the category relationship from the transaction data information and the product name information registered by the buyer company. In addition, when the category group ID 1002 is acquired from the shared category registration function 128 with the category name acquired by the category matching function 127, the shared category registration function 128 registers the category name acquired as the category group ID 1002 in the shared category name dictionary information 139. In this way, it becomes possible to register an appropriate category name.

FIG. 21 is a flowchart illustrating a process in which the category matching function 127 of the application server 120 registers the information of the supplier company with respect to the category name of the buyer company in the category relationship information 138 of the buyer company. The category matching function 127 checks whether the category ID 605 and the category name 606 of the data record acquired from the category registration request information 135 are registered in the category relationship information 138 (S1902). In the case that they are not registered (S1903), the category matching function 127 newly registers the company ID 601, the category ID 605, and the category name 606 of the acquired data record in the buyer company ID 901, the buyer category ID 902, and the buyer category name 903 of the category relationship information 138, respectively (S1904).

In the case that they are registered (S1903), the category matching function 127 extracts the category group ID 1002 from the shared category name dictionary information 139 based on the category name 606 of the acquired data record (S1905). The category matching function 127 extracts the list of category names 1003 from the shared category name dictionary information 139 based on the extracted category group ID 1002 (S1906). The category matching function 127 extracts the list of the company IDs 801 and the category IDs 802 from the supplier category information 137 based on the extracted list of category names 1003 (S1907). The category matching function 127 checks whether or not the list of company IDs 801 and category IDs 802 has been extracted (S1908), sets the status 608 of the acquired data record to complete when there is no extracted list (S1913), and performs the registration process (S1602) of the next data record (S1914).

In the case that there is an extracted list of the company IDs 801 and the category IDs 802, the category matching function 127 determines that a category relationship has been detected in the category information registered by the file data registration function 118, and registers information indicating the degree of relevance in the category relationship information 138. First, the category matching function 127 confirms the degree of relevance 906 of the category relationship information 138 with respect to the company ID 601, the category ID 605, the category name 606, and the extracted list of company IDs 801 and category IDs 802 of the acquired data record (S1909). In the case that the value of the degree of relevance 906 is NULL (S1910), the category matching function 127 registers the degree of relevance 906 as 1 (category matching) (S1911).

In the case that the value of the degree of relevance 906 is 1 or greater (S1910), the category matching function 127 registers a degree of relevance 906 of 2 (estimate present) for acquired data records having an information classification 603 of estimate information and registers a degree of relevance 906 of 3 (order present) for the acquired data records having an information classification of order information (S1912). The category matching function 127 sets the status 608 of the category registration request information 135 of the registered data record to complete (S1913), and the registration process (S1602) of the next data record is performed (S1914). In this way, the category matching function 127 acquires the list of category names from the category group ID 1002 of the category name 1003 from the shared category name dictionary information 139, and detects category relationships with respect to the list of the acquired category names. In this way, it becomes possible to register appropriate category names.

FIG. 22 is a flowchart illustrating a process in which the shared category registration function 128 of the application server 120 registers the category name of the supplier company in the shared category name dictionary information 139. The shared category registration function 128 checks whether or not the category name 606 of the data record acquired from the category registration request information 135 is registered in the supplier product name information 134 for a data record that is not registered in the shared category name dictionary information 139 (S2002). In the case that it is not registered (S2003), the shared category registration function 128 newly registers the category name 606 of the acquired data record in the shared category name dictionary information 139 (S2004), and then performs the supplier category matching function process (S2101).

In the case that it is registered (S2003), the shared category registration function 128 extracts the list of the receiver product name code 503 from the supplier product name information 134 based on the category name 606 of the acquired data record (S2005). The shared category registration function 128 extracts the list of the category IDs 402 from the buyer product name information 133 based on the extracted list of the receiver product name code 503 (S2006). The shared category registration function 128 extracts the list of orderer product name codes 405 from the buyer product name information 133 based on the extracted list of category IDs 402 (S2007). The shared category registration function 128 extracts the list of category IDs 402 from the buyer product name data 133 based on the list of the extracted orderer product name codes 405 (S2008). The shared category registration function 128 extracts the list of category names 703 from the buyer category information 136 based on the extracted list of category IDs 402 (S2009).

The shared category registration function 128 checks whether the extracted category name 703 list is registered in the shared category name dictionary information 139 (S2010), and in the case that it is not registered (S2011), newly registers the category name 606 of the acquired data record in the shared category name dictionary information 139 (S2004). In the case that it is registered (S2011), the shared category registration function 128 extracts the category group ID 1002 (S2012) and registers the category name 606 of the acquired data record as the extracted category group ID 1002 in the shared category name dictionary information 139 (S2013). The supplier category matching function process is performed for the registered category name 1003 (S2101).

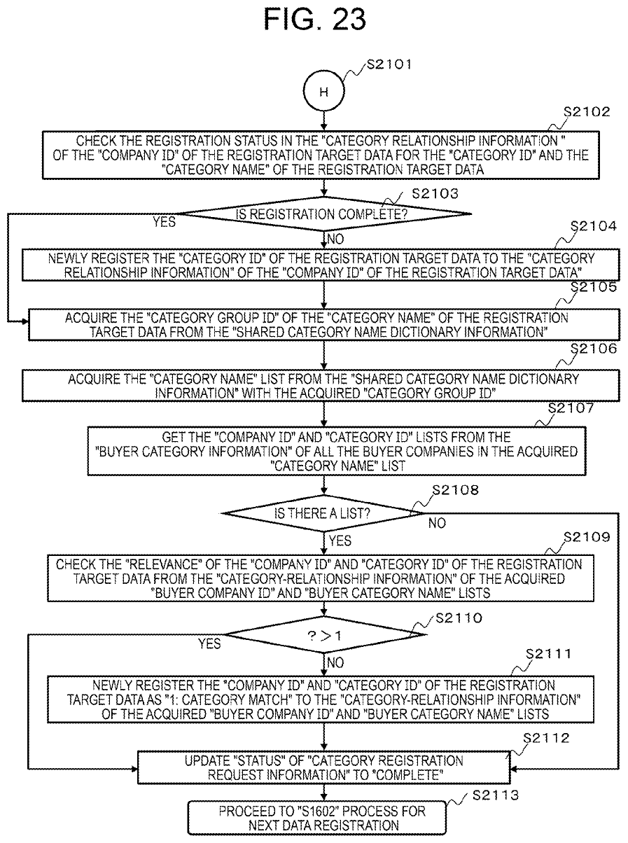

FIG. 23 is a flowchart illustrating a process in which the category matching function 127 of the application server 120 updates the category relationship information 138 of the buyer company with respect to the category name of the supplier company. The category matching function 127 checks whether the category ID 605 and the category name 606 of the data record acquired from the category registration request information 135 are registered in the category relationship information 138 (S2102), and in the case that they are not registered (S2103), newly registers the company ID 601, the category ID 605, and the category name 606 of the acquired data record in the buyer company ID 901, the buyer category ID 902, and the buyer category name 903 of the category relationship information 138, respectively, (S2104).

In the case that it is registered (S2103), the category matching function 127 extracts the category group ID 1002 from the shared category name dictionary information 139 based on the category name 606 of the acquired data record (S2105). The category matching function 127 extracts the list of category names 1003 from the shared category name dictionary information 139 based on the extracted category group ID 1002 (S2106). The category matching function 127 extracts the list of company IDs 701 and category IDs 702 from the buyer category information 136 based on the extracted list of category names 1003 (S2107). In the case that there is no extracted list (S2108), the category matching function 127 sets the status 608 of the category registration request information 135 of the acquired data record (S2112) as complete, and performs the registration process (S1602) for the next data record (S2113).

In the case that there is a list of the extracted company IDs 801 and category IDs 802 (S2108), the category matching function 127 determines that a category relationship has been detected in the category information registered by the file data registration function 118, and registers information indicating the degree of relevance in the category relationship information 138. First, the category matching function 127 checks the degree of relevance 906 of the category relationship information 138 with respect to the company ID 601, category ID 605, and the extracted company ID 801 of the acquired data record and the list of category IDs 802 (S2109). In the case that the value of the degree of relevance 906 is NULL (S2110), the category matching function 127 registers the degree of relevance 906 as 1 (category matching) (S2111). In the case that the value of the degree of relevance 906 is 1 or more (S2110), the category matching function 127 sets the status 608 of the category registration request information 135 of the acquired data record (S2112) as complete, and performs the registration process (S1602) for the next data record (S2113).

As described above, in the transaction managing system 1, the file reception function 116 receives data files transmitted by external systems such as the buyer company in-house system 103 and the supplier company in-house system 104 and the file transmission function 123, and registers the content of the received data file as an un-processed file in the information classification of the registration target data file in the file reception information 131 (S1103). In this way, the transaction management system 1 can be easily constructed by means of receiving transaction information such as product names code from data files that can be acquired from an external system that serves as an IT core system of a buyer company or a supplier company.

Including the contents of the data files specified by file name 203, the file reception information 131 receives and maintains information about e-commerce (estimate information order information) conducted between an orderer (the buyer company) and a receiver (the supplier company), exchanged product name information, or category information including a product name, in addition to the information classifications (estimate information, order information, product name information, category) corresponding to the e-commerce information, the product name information, or the category information. The file data registration function 118, which serves as a data registration function, performs registration processing in the information management table 130 for each information classification 205 of the file reception information 131 in which the information is stored.

That is, the file data registration function 118 performs the buyer transaction data registration process (S1201) when the information classification 205 is transaction data (estimate information, order information). In the buyer transaction data registration process, the file data registration function 118 registers the content of the file data of the transaction data in the transaction data classification 205 in the transaction data information 132 (S1203), the buyer product name information 133 (S1204), and the category registration request information 135 (S1212).

In addition, the file data registration function 118 performs the buyer product name registration process (S1301) in the case that the information classification 205 is product name information and the applicant classification 202 of the file reception information 131 is a buyer company, and performs the supplier product name registration process (S1401) in the case that the applicant classification 202 of the file reception information 131 is a supplier company (S1112). In the buyer product name registration process, the file data registration function 118 registers, in the buyer product name information 133 (S1306) and the category registration request information 135 (S1311), a data file in which the applicant company classification 202 of the file reception information 131 is buyer and the information classification 205 is product name information. In the supplier product name registration process, the file data registration function 118 registers, in the supplier product name information 134 (S1406) and the category registration request information 135 (S1407), a data file in which the applicant company classification 202 of the file reception information 131 is supplier and the information classification 205 is product name information.

In addition, in the case that the information classification 205 is category information, the file data registration function 118 registers the acquired data line as an unprocessed data file in the category registration request information 135 (S1115). In this way, the file data registration function 118 registers the category information in the category registration request information 135 and aggregates the registration of the category information into the category registration request information 135. As a result, by unifying the list registration function 125 and the interface, the transaction management system 1 can be easily constructed.

The list registration function 125, which serves as a data registration function, registers the transaction data, the product name information, and the category information for which there was a data update in the category registration request information 135 as un-processed data files (S1510). In the case that there was no update, the file transmission function 123 transmits the data file to the file reception server 113, and the transmitted data file is processed by the file reception function 116 and then processed as described above.

The category information included in the data file transmitted by the buyer company in-house system 103, the supplier company in-house system 104, and the file transmission function 123 is once aggregated into the category registration request information 135 from the file data registration function 118 and the list registration function 125, which serve as data registration functions. The category information aggregated in the category registration request information 135 is registered or updated by the shared category registration function 128 with the category data of the buyer company with respect to the buyer category information 136 (S1612, S1613), or

registered or updated with the category data of the supplier company with respect to the supplier category information 137 (S1710, S1711). Accordingly, the data registration function (the file data registration function 118 and the list registration function 125) registers all the detected category information when category information for an unregistered product name code is detected in the product name information.

In addition, the category name of the registration target data is registered by the shared category registration function 128 with the category name of the buyer company and the category name of the supplier company in the shared category name dictionary information 139 (S1804, S2004).

The category matching function 127 checks whether the category ID 605 and the category name 606 of the data record acquired from the category registration request information 135 are registered in the category relationship information 138 (S1902), thereby comparing the product name information or the category information registered by the data registration function with the category information (the buyer category ID 902 and the buyer category name 903) acquired from the category relationship information 138 that includes the degree of relevance. As a result of the comparison, if there is no item corresponding to the category relationship information 138, the category matching function 127 registers the company ID 601, the category ID 605, and the category name 606 of the data record acquired from the category registration request information 135 in the buyer company ID 901, the buyer category ID 902, and the buyer category name 903 of the category relationship information 138, respectively (S1904).

The category matching function 127 checks whether the category name 606 of the acquired data record is present in the category name 1003 of the shared category name dictionary information 139 (S1906), and further checks (S1907) whether the existing category name 1003 is present in the category ID 802 of the supplier category information 137. If it is present, it is determined that a category relationship has been detected in the category information registered by the data registration function, and the category matching function 127 registers information indicating the degree of relevance in the category relationship information 138. That is, in the case that the value of the degree of relevance 906 of the category relationship information 138 with respect to the company ID 601, the category ID 605, or the category name 606 of the acquired data record or the list of the extracted company ID 801 and category ID 802 is NULL (S1910); that is, in the case that the category matches for the first time (S1911), the category matching function 127 registers the relevance degree 906 as 1 (category matching).

As described above, in the transaction management system 1, a candidate supplier company can be searched based on the degree of relevance between the category information of a buyer company and the category information of a supplier company, which is derived by analyzing the relationship between the buyer company and the supplier company from the various category code systems managed by a large number of buyer companies or supplier companies. In this way, it becomes possible for buyer companies to find new suppliers that have established records in other departments, even if that supplier company does not have an established record in a particular division, and to search for suitable candidate supplier companies from the information of existing supplier companies and new supplier companies that have transactions, while maintaining a category code system that differs between buyer departments. In addition, buyer companies can efficiently select suitable candidate supplier companies from accurate and consistent supplier company management information. Further, suppliers can also increase the probability of conducting transactions with buyer companies with which they do not have transaction records.

In the transaction management system 1, in the case that the value of the degree of relevance 906 is 1 or greater (S1910), the category matching function 127 registers a degree of relevance 906 of 2 (estimate present) for acquired data records having an information classification 603 of estimate information and registers a degree of relevance 906 of 3 (order present) for the acquired data records having an information classification of order information (S1912). In this way, the category matching function 127 registers information indicating a different degree of relevance in the category relationship information 138 according to the information classification of the acquired product name code in the detected category relationship. In this way, the transaction management system 1 can search for a more suitable candidate supplier company by changing the degree of relevance according to the information classification.

Also, what has been described above is a transaction management method for managing transactions between a buyer company and a supplier company by using information about e-commerce conducted between the two. This transaction management method is a transaction management method that includes receiving information about e-commerce conducted between a buyer and a supplier, information about a product name that is dealt with in the e-commerce, or information about a category including a product name together with information classifications of e-commerce information, product name information, or category information; registering, when category information for an unregistered product name code is detected in product name information, the detected category information; comparing registered category information 138 and category relationship information including a degree of relevance between category information of a buyer and category information of a supplier; registering, when a category relationship is detected in registered category information 138, information indicating the relevance in category relationship information; and outputting, electronically or visually, at least information indicating the degree of relevance.

By means of this transaction management method, similarly to the transaction management system 1 described above, a candidate supplier company can be searched based on the degree of relevance between the category information of a buyer company and the category information of a supplier company, which is derived by analyzing the relationship between the buyer company and the supplier company from the various category code systems managed by a large number of buyer companies or supplier companies. In this way, it becomes possible for buyer companies to find new suppliers that have established records in other departments, even if that supplier company does not have an established record in a particular division, and to search for suitable candidate supplier companies from the information of existing supplier companies and new supplier companies that have transactions, while maintaining a category code system that differs between buyer departments. In addition, buyer companies can efficiently select suitable candidate supplier companies from accurate and consistent supplier company management information. Further, suppliers can also increase the probability of conducting transactions with buyer companies with which they do not have transaction records.

By means of the above configuration, a buyer company can efficiently acquire and share the latest information on the products and services to be updated by the supplier company, thereby reducing the cost of improving the manageability between buyers and between other departments.

It should be noted that the present invention is not limited to the illustrated embodiments, but can be implemented by a configuration within a scope not deviating from the content described in each claim. That is, although the present invention has been particularly illustrated and described primarily with respect to specific embodiments, various modifications may be made by those skilled in the art in regard to quantity and other detailed configurations of the embodiments described above without departing from the spirit and scope of the invention.

### REFERENCE SIGNS LIST

113 . . . File reception server, 117 . . . format conversion function, 118 . . . file data registration function, 125 . . . list registration function, 127 . . . category matching function, 128 . . . shared category registration function, 131 . . . file reception information, 132 . . . transaction data information, 133 . . . buyer product name information, 134 . . . supplier product name information, 135 . . . category registration request information, 136 . . . buyer category information, 137 . . . supplier category information, 138 . . . category relationship information, 139 . . . shared category name dictionary information

1. A transaction management system for managing transactions between a buyer and a supplier by using information on e-commerce between the buyer and the supplier, the transaction management system comprising:
a data registration function configured to register information about e-commerce conducted between a buyer and a supplier, information about a product name that is dealt with in the e-commerce, or information about a category including a product name for each information classification of e-commerce information, product name information, or category information; and
a category matching function configured to perform a comparison between category information registered by the data registration function and category relationship information including a degree of relevance between category information of a buyer and category information of a supplier,
wherein:
when category information related to an unregistered product name code is detected in product name information, the data registration function registers the detected category information, and
when a category relationship is detected in category information registered by the data registration function, the category matching function registers information indicating the degree of relevance in category relationship information.

2. The transaction management system of claim 1, further comprising:
a format conversion function for a data file;
wherein:
the data registration function is a file data registration function configured to register a data file including a product name code acquired from an external system for each information classification, and
the file data registration function registers, to transaction data information, buyer product name information, or supplier product name information, information for a data file obtained by converting a format of an acquired data file using the format conversion function for each information classification.

3. The transaction management system of claim 2, wherein:
the file data registration function registers category information to category registration request information.

4. The transaction management system of claim 1, wherein:
the data registration function is a list registration function configured to register, for each information classification, data to be updated from a list display screen; and
the list registration function registers, for each information classification, data to be updated from the list display screen to transaction data information, buyer product name information, or supplier product name information.

5. The transaction management system of claim 1, further comprising:
a shared category registration function configured to register unregistered category information in shared category name dictionary information;
wherein:
in a case that a category name for a product name code is not registered in shared category name dictionary information, the shared category registration function extracts all category IDs registered as that product name code from buyer product name information or supplier product name information, and acquires a category name from buyer category information or supplier category information with an extracted category ID.

6. The transaction management system of claim 5, wherein:
when a category group ID is acquired from a shared category registration function with a category name acquired by the category matching function, the shared category registration function registers a category name acquired as the category group ID in shared category name dictionary information.

7. The transaction management system of claim 6, wherein:
the category matching function acquires a list of category names from a category group ID of a category name from shared category name dictionary information, and detects a category relationship with respect to the acquired list of category names.

8. The transaction management system of claim 1, wherein:
the category matching function registers, in category relationship information, information indicating a different degree of relevance according to an information classification of an acquired product name code in a detected category relationship.

9. The transaction management system according to claim 1, further comprising:
an output function configured to electronically or visually output information indicating at least the degree of relevance.

10. A transaction management method for managing transactions between a buyer and a supplier by using information on e-commerce between the buyer and the supplier, the transaction management method comprising:
receiving information about e-commerce conducted between a buyer and a supplier, information about a product name that is dealt with in the e-commerce, or information about a category including a product name together with information classifications of e-commerce information, product name information, or category information;
registering, when category information for an unregistered product name code is detected in product name information, the detected category information;
comparing registered category information and category relationship information including a degree of relevance between category information of a buyer and category information of a supplier;
registering, when a category relationship is detected in registered category information, information indicating the relevance in category relationship information; and
outputting, electronically or visually, at least information indicating the degree of relevance.
